(19) United States
(12) Patent Application Publication
(10) Pub. No.: US 2025/0259027 A1
(43) Pub. Date: Aug. 14, 2025

(54) NON-TRANSITORY COMPUTER-READABLE STORAGE MEDIUM STORING PRINTING PROGRAM, PRINTED MATTER GENERATION METHOD, PRINTING SYSTEM, SPECIAL PLATE DATA GENERATION METHOD, SPECIAL PLATE DATA GENERATION SYSTEM, AND NON-TRANSITORY COMPUTER-READABLE STORAGE MEDIUM STORING SPECIAL PLATE DATA GENERATION PROGRAM

(71) Applicant: SEIKO EPSON CORPORATION, TOKYO (JP)

(72) Inventor: Takumi YAMAGUCHI, MATSUMOTO-SHI (JP)

(21) Appl. No.: 19/053,446

(22) Filed: Feb. 14, 2025

(30) Foreign Application Priority Data
Feb. 14, 2024 (JP) 2024-020070

(51) Int. Cl. G06K 15/12; B41J 2/21; G06K 15/02

(52) U.S. Cl. CPC G06K 15/1276; B41J 2/2132; G06K 15/129; G06K 15/1882

(57) ABSTRACT

A non-transitory computer-readable storage medium stores a program including: a special plate generation function for generating special plate data based on image data; a special plate printing function for printing the special plate data using special color ink; and an image printing function for printing the image data at a position overlapping the special color ink. A relative position between a position at which the special color ink of the special plate data is printed and a position of an object of the image data corresponds to a type of the object.

The present application is based on, and claims priority from JP Application Serial Number 2024-020070, filed Feb. 14, 2024, the disclosure of which is hereby incorporated by reference herein in its entirety.

### BACKGROUND

### 1. Technical Field

The present disclosure relates to non-transitory computer-readable storage medium storing a printing program, a printed matter generation method, a printing system, a special plate data generation method, a special plate data generation system, and a non-transitory computer-readable storage medium storing a special plate data generation program.

### 2. Related Art

In the related art, in a case where printing is performed on printing media other than white, a method is known in which white ink is printed in advance as a base in a region having substantially the same shape as the shape of a print image (for example, JP-A-2018-12262).

Although a method of automatically generating a white plate has been known in the related art, a white plate is generated by the same logic for any image. It is possible to use an existing image processing application to generate a special plate in a desired mode, but this is not easy work for an inexperienced user.

### SUMMARY

A non-transitory computer-readable storage medium for solving the aforementioned problem stores a printing program including: a special plate generation function for generating special plate data based on image data; a special plate printing function for printing the special plate data using special color ink; and an image printing function for printing the image data at a position overlapping the special color ink. A relative position between a position at which the special color ink of the special plate data is printed and a position of an object of the image data corresponds to a type of the object.

A printed matter generation method for solving the aforementioned problem includes: generating special plate data based on image data; printing the special plate data using special color ink; and printing the image data at a position overlapping the special color ink to generate a printed matter. A relative position between a position at which the special color ink of the special plate data is printed and a position of an object of the image data corresponds to a type of the object. A printing system for solving the aforementioned problem includes: a special plate generation unit that generates special plate data based on image data; a special plate printing unit that prints the special plate data using special color ink; and an image printing unit that prints the image data at a position overlapping the special color ink. A relative position between a position at which the special color ink of the special plate data is printed and a position of an object of the image data corresponds to a type of the object.

A special plate data generation method for solving the aforementioned problem includes: determining a type of an object in image data; and generating special plate data based on the image data. A relative position between a position at which special color ink of the special plate data is printed and a position of the object of the image data corresponds to a type of the object.

A special plate data generation system for solving the aforementioned problem includes: an object determination unit that determines a type of an object in image data; and a special plate generation unit that generates special plate data based on the image data. A relative position between a position at which special color ink of the special plate data is printed and a position of the object of the image data corresponds to a type of the object.

A non-transitory computer-readable storage medium for solving the aforementioned problem stores a special plate data generation program including: an object determination function for determining a type of an object in image data; and a special plate generation function for generating special plate data based on the image data. A relative position between a position at which special color ink of the special plate data is printed and a position of the object of the image data corresponds to a type of the object.

### BRIEF DESCRIPTION OF THE DRAWINGS

FIG. 1 is a block diagram of a printing system.

FIG. 2 is a block diagram of a printer.

FIG. 3 is a block diagram of a print control device.

FIG. 4 is a block diagram of a user terminal.

FIG. 5 is a schematic diagram showing a relationship between image data and white plate data.

FIG. 6 is a diagram showing examples of types of objects and white plate generation patterns.

FIG. 7 is a diagram showing an example of image data and white plate data.

FIG. 8 is a diagram showing an example of image data and white plate data.

FIG. 9 is a diagram showing an example of image data and white plate data.

FIG. 10 is a view showing an example of a print preview.

FIG. 11 is a flowchart showing a printing process.

### DESCRIPTION OF EMBODIMENTS

Here, embodiments of the present disclosure will be described in the following order.
(1) Configuration of Printing System:
(1-1) Configuration of Printer:
(1-2) Configuration of Print Control Device:
(1-3) Configuration of User Terminal:
(2) Printing Process:
(3) Other Embodiments:

### (1) Configuration of Printing System

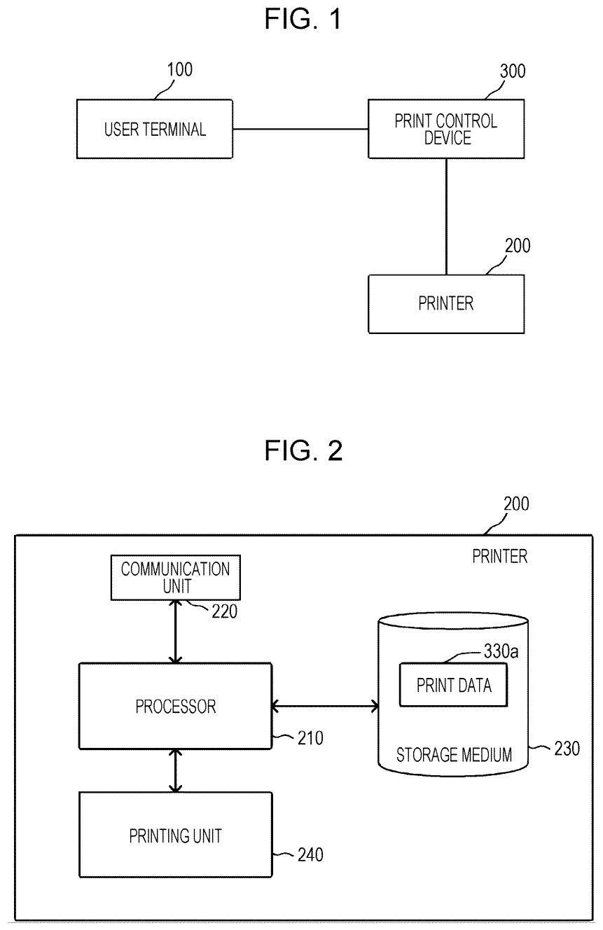

FIG. 1 is a block diagram showing the configuration of a printing system according to an embodiment of the present disclosure. The printing system according to the present embodiment includes a printer 200, a print control device 300, and a user terminal 100. The printer 200 according to the present embodiment is a UV printer that forms an image by discharging UV ink onto a print medium such as an acrylic plate. The user terminal 100 is a device used by a user who creates and edits submitted data. The print control device 300 functions as a raster image processor (RIP) that converts submitted data into print data suitable for printing by the printer 200 and causes the printer 200 to execute printing based on the print data.

### (1-1) Configuration of Printer:

FIG. 2 is a block diagram showing the configuration of the printer 200. The printer 200 is a printing device that prints an image on a print medium in response to an instruction from the print control device 300. In the present embodiment, the printer 200 performs printing on a print medium using inks of respective colors of cyan (C), magenta (M), yellow (Y), and black (K). In addition, the printer 200 can also use special color ink such as white ink or ink for obtaining a surface effect (for example, clear ink). The ink used in the printer 200 according to the present embodiment is UV ink. The printer 200 performs printing by discharging UV ink onto a print medium and irradiating the discharged UV ink with ultraviolet light.

The printer 200 includes a processor 210, a communication unit 220, a storage medium 230, and a printing unit 240. In addition, the printer 200 includes a RAM and a ROM (not shown). The processor 210 controls the printer 200 by executing various programs stored in the ROM, the storage medium 230, and the like. The processor 210 may be configured by a single chip or may be configured by a plurality of chips. In addition, in the present embodiment, the processor 210 is a CPU, but may be configured by an ASIC or the like, or may be configured by a CPU and an ASIC. When each device according to the present embodiment includes a processor, the processor can be realized in various forms, similarly to the processor 210.

The communication unit 220 includes a circuit used for communication with an external device, such as the print control device 300, according to various wired or wireless communication protocols. The storage medium 230 stores various programs, such as a control program for controlling the execution of printing, and print data 330a transmitted from the print control device 300. The printing unit 240 includes an actuator, a driving circuit, a mechanical component, a sensor, and the like for performing printing by discharging the UV ink onto the print medium and irradiating the print medium with ultraviolet rays. The processor 310 performs printing by controlling the printing unit 240 based on the print data 330a. The print data 330a will be described later.

### (1-2) Configuration of Print Control Device:

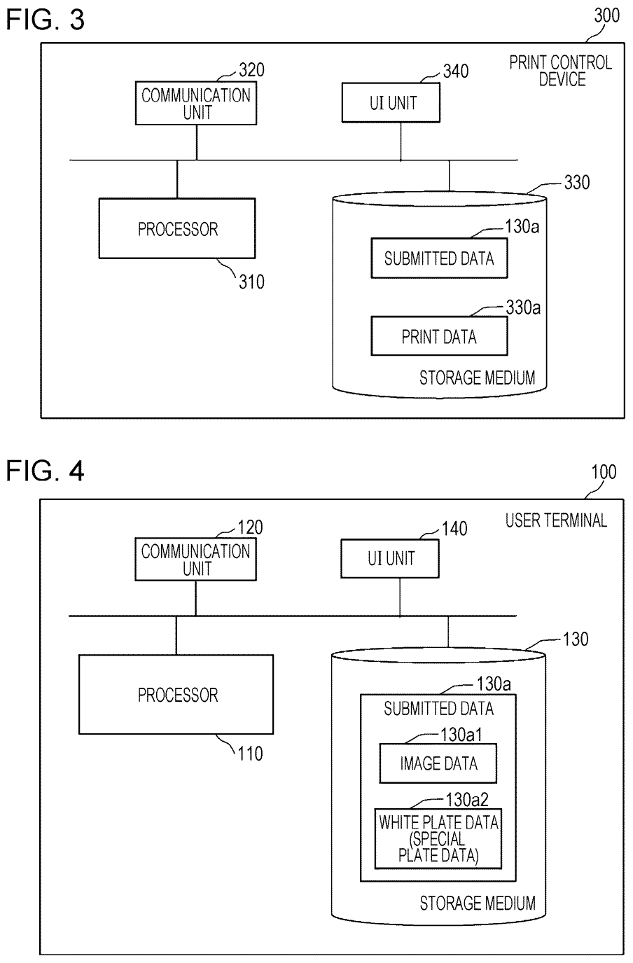

FIG. 3 is a block diagram showing the configuration of the print control device 300. The print control device 300 includes a processor 310, a communication unit 320, a storage medium 330, and a UI unit 340. The processor 310 controls the print control device 300 by executing various programs stored in the ROM (not shown), the storage medium 330, and the like.

The communication unit 320 includes a circuit used for communication with an external device, such as the printer 200 or the user terminal 100, according to various wired or wireless communication protocols. The storage medium 330 stores various programs including a RIP program for executing a process of controlling printing via the printer 200, submitted data 130a acquired from the user terminals 100, print data 330a generated based on the submitted data 130a, and the like. A print image to be printed on a print medium has a plurality of layers, and each layer is referred to as a plate. In the present embodiment, the print image is configured by a color plate and a white plate. In this specification, data indicating an image to be printed on a color plate is referred to as image data, and data indicating an image to be printed on a white plate (special plate) is referred to as white plate data (special plate data). The white plate image is printed on the print medium before the color plate image.

The processor 310 of the print control device 300 executes the RIP program to generate print data based on the submitted data 130a. The print data is data indicating a form of printing to be executed by the printer 200. Specifically, the processor 310 enlarges or reduces the data of each plate indicated by the submitted data 130a based on the image resolution indicated by the printing conditions. Then, the processor 310 converts the enlarged or reduced data into gradation data for each color of ink used in the printer 200. Then, the processor 310 performs halftone processing based on the converted gradation data to determine the color and the amount of ink to be discharged to each pixel. The processor 310 generates data indicating the amount of each ink for each pixel of the print medium, as the print data 330a, for each of the color plate and the white plate.

### (1-3) Configuration of User Terminal:

FIG. 4 is a block diagram showing the configuration of the user terminal 100. The user terminal 100 includes a processor 110, a communication unit 120, a storage medium 130, and a UI unit 140. The processor 110 controls the user terminal 100 by executing various programs stored in the ROM (not shown), the storage medium 130, and the like.

The communication unit 120 includes a circuit used for communication with an external device, such as the print control device 300, according to various wired or wireless communication protocols. The communication unit 120 includes an interface for communicating with various removable memories mounted on the user terminal 100. The storage medium 130 stores various programs including a program for generating and editing image data and a printing program for generating the submitted data 130a based on image date, and various kinds of information such as the submitted data 130a. The submitted data 130a includes image data 130a1 and white plate data (special plate data) 130a2.

The UI unit 140 includes an input unit, such as a mouse, a keyboard, a touch pad, or an operation unit of a touch panel, which receives an input from a user, and an output unit, such as a monitor, a display unit of a touch panel, or a speaker, which is used to present information to the user.

The processor 110 realizes a special plate generation function, a special plate printing function, and an image printing function by executing the printing program. The special plate generation function is a function of generating special plate data based on image data. The special plate printing function is a function of printing special plate data using a special color ink. The image printing function is a function of print image data at a position overlapping the special color ink. In the present embodiment, the processor 110 functions as a special plate generation unit, a special plate printing unit, and an image printing unit. In the present embodiment, white ink for a base is assumed as the special color ink, and a white plate is assumed as the special plate.

When printing is performed on a transparent print medium or a print medium other than white, the color of the image data is expressed lightly or expressed in a different color. Therefore, white ink is printed as a base of a region to which color ink is discharged. The user can automatically generate data of a plate (white plate) to be printed with white ink using an existing image processing application. In this case, however, white plate data is generated by the same logic for any image. It is also possible to manually generate white plate data in a desired form by using an existing image processing application, but this is not easy work for an inexperienced user. Therefore, in the present embodiment, a function of automatically obtaining a white plate without using such an existing application is realized.

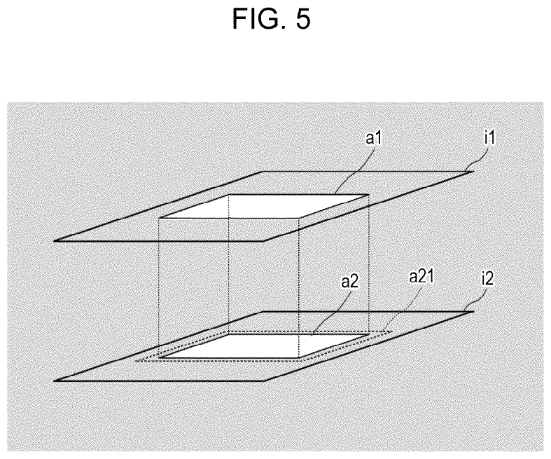

In the present embodiment, the processor 110 sets a relative position at which the white ink is printed in the white plate data with respect to the position of the object according to the type of the object included in the image data. FIG. 5 is a schematic view showing the relationship between image data and white plate data. In FIG. 5, i1 indicates data of a color plate (image data) for printing a region a1 of an object with the color inks of C, M, Y, and K, and i2 indicates data of a white plate (white plate data) for printing with white ink. a1 indicates an example of a region of an object to which color ink is discharged in the image data i1, and a2 is a region overlapping the object region a1 in the white plate data i2. A region a21 is larger than the region a2 by a predetermined width. In the present embodiment, three patterns are assumed: a pattern in which white ink is not printed as a base of an object (that is, a pattern in which white ink is not printed in the white plate data i2 for the region a1 of the image data i1), a pattern in which white ink is printed at a position overlapping the object without protruding from the object (that is, a pattern in which white ink is printed in the region a2 of the white plate data i2 for the region a1 of the image data i1), and a pattern in which white ink is printed on an object and at a position protruding from the object (that is, a pattern in which white ink is printed in the region a21 of the white plate data i2 for the region a1 of the image data i1).

When executing the printing program, the processor 110 also realizes a preview function for performing a print preview in a selectable manner for a plurality of pieces of generated white plate data. The processor 110 presents a print preview when the plurality of pieces of white plate data are adopted, so that the user selects one of the patterns. The processor 110 generates the submitted data 130a including the white plate image of the pattern selected by the user and the image data (when a pattern that requires processing on image data is selected, processed image data). The special plate printing function prints the white ink based on the selected white plate data.

Next, an example of generating white plate data according to the type of an object included in image data will be specifically described. The printing program also has an object determination function for determining the type of an object included in image data. The processor 110 performs image recognition processing on the image data, extracts an object included in the image data, and determines the type of the object. The processor 110 extracts an object included in the image data by using a known algorithm such as edge extraction or region division of an image or a machine learning model. In addition, the processor 110 determines the type of the extracted object using pattern matching, template matching, distribution analysis of a gradation value, or a machine learning model.

The processor 110 regards an object, for which the ratio of the area of the object to the area of the entire image is equal to or greater than a threshold value, as a main object. Alternatively, when there are an object in focus and an object out of focus in the image, the processor 110 regards the object in focus as a main object. For example, whether or not the object is in focus can be determined based on the sharpness of the image data.

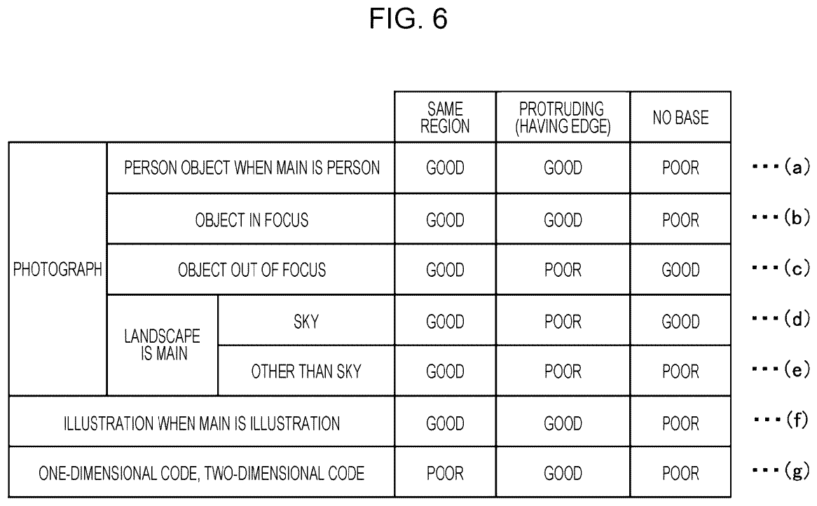

When a person is a main object in the image data, the processor 110 generates white plate data for printing white ink at a position of a person object indicating the person and a position protruding from the person object. Therefore, according to the present embodiment, it is possible to obtain white plate data for printing white ink in a region larger than a person for image data in which the person is a main object. In addition, the processor 110 also generates white plate data for printing white ink at the position of the person object so as not to protrude from the person object. That is, in the present embodiment, when the person is a main object, as shown in (a) of FIG. 6, a pattern in which the white ink is printed so as not to protrude from the position of the person object (the same region) and a pattern in which the white ink is printed so as to protrude from the position of the person object are proposed to the user.

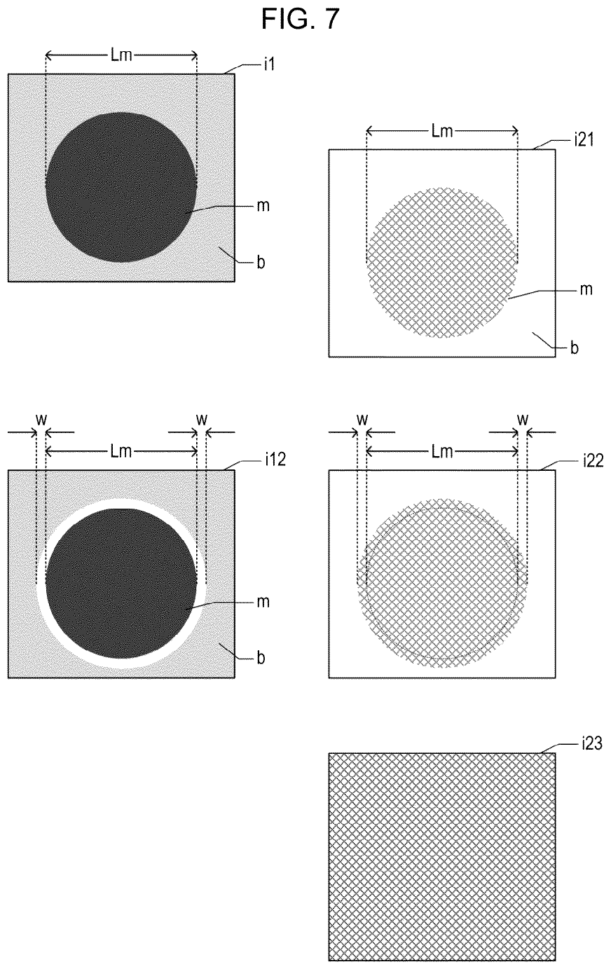

This will be described more specifically with reference to FIG. 7. FIG. 7 is a diagram illustrating an example of image data (color plate data) and white plate data thereof (data of white plate). The image data i1 shown in FIG. 7 schematically shows an example in which a main object m and a background object b other than the main object m are included. The white plate data i21 is white plate data indicating that the white ink is printed in a region where the object m is printed so as not to protrude from the object m and no white ink is printed at the position of the background object b.

The white plate data i22 is white plate data indicating that the white ink is printed in a region where the object m is printed and a region protruding from the outer edge of the object m by a predetermined width w and the white ink is not printed in the other regions. In this case, the processor 110 processes the image data i1 as the image data i12.

Specifically, the processor 110 sets a region having a width w from the outer edge of the object m (a part of the background object b that is a region corresponding to the border of the object m) as a region where no ink is discharged in the color plate (a region where the white ink of the base is transmitted).

In this manner, it is possible to obtain an effect of emphasizing the object by adding a white border to the main object m. Since the region where the special color ink is printed may be different according to the type of the object, an effect of changing the impression of the printing result can be expected by processing the image data according to the mode of the region where the special color ink is printed.

The processor 110 determines whether the main object of the image data is an illustration or a photograph using, for example, a machine learning model. When the illustration is a main object in the image data, the processor 110 generates white plate data for printing the white ink at the position of the illustration and a position protruding from the illustration. Therefore, according to the present embodiment, it is possible to obtain the white plate data for printing the white ink in a region larger than the illustration itself with respect to the image data in which the illustration is the main object. In addition, the processor 110 also generates white plate data for printing the white ink at the position of the illustration so as not to protrude from the illustration. That is, in the present embodiment, when the illustration is a main object, as shown in (f) of FIG. 6, a pattern in which the white ink is printed so as not to protrude from the region of the object itself of the illustration and a pattern in which the white ink is printed together with the object itself of the illustration and a region (edge) protruding from the object are proposed to the user.

When the image data is a photograph, the processor 110 extracts an object that is in focus in the photograph as described above. The processor 110 generates white plate data that does not protrude from the object in focus. Therefore, in this case, it is possible to obtain white plate data for printing the white ink without protruding to the position of the in-focus object itself. In addition, the processor 110 also generates white plate data for printing white ink on the region of the in-focus object itself and a region (edge) protruding from the object.

In addition, when the image data is a photograph, the processor 110 generates white plate data for printing white ink at a position corresponding to the in-focus object without printing white ink at a position corresponding to an out-of-focus object. Therefore, in this case, it is possible to obtain white plate data capable of producing an effect of the special color ink, that is, an effect of improving color development by printing the white ink as a base in the present embodiment, in an object in focus rather than an object out of focus.

That is, in the present embodiment, for an object that is in focus in the photograph, as shown in (b) of FIG. 6, both of a pattern in which white ink is printed in a region of the object itself and a pattern in which white ink is printed in the object itself and a region protruding from the object are proposed to the user. In addition, for an object that is out of focus, as shown in (c) of FIG. 6, a pattern in which white ink is printed in the region of the object itself and a pattern in which no white ink is printed in the region of the object are proposed to the user.

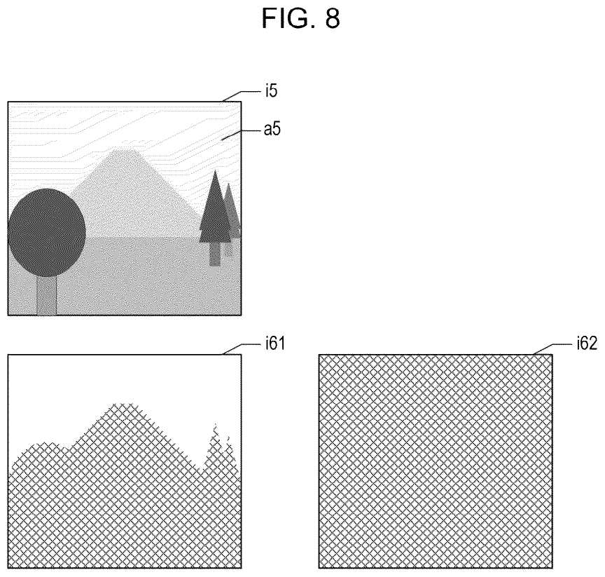

The processor 110 determines whether or not a landscape is a main object in the image data using a machine learning model. When the landscape is a main object in the image data, the processor 110 divides the image data into regions and detects a sky region. The processor 110 generates white plate data in which no white ink is printed at a position corresponding to the sky and the white ink is printed at a position corresponding to the object, which is not the sky, so as not to protrude to the sky. Therefore, it is possible to obtain white plate data that can express the transparency of the sky. Image data i5 in FIG. 8 shows an example of a landscape photograph including a sky region a5, and white plate data i61 shows that no white ink is printed in a region corresponding to the sky and the white ink is printed in a region other than the sky without protruding to the sky.

In addition, the processor 110 also generates white plate data for printing the white ink in the region of the object itself, regardless of whether it is the sky or not, without protruding, as shown in the white plate data i62 in FIG. 8. That is, in the present embodiment, in the case of a landscape photograph, for an object indicating the sky, as shown in (d) of FIG. 6d, a pattern in which white ink is printed at the position of the object itself without protruding and a pattern in which no white ink is printed at the position of the object are proposed to the user. For an object other than the sky in the landscape photograph, as shown in (e) FIG. 6, a pattern in which white ink is printed in the region of the object itself is proposed to the user.

The processor 110 determines whether a one-dimensional code or a two-dimensional code is included in the image data by, for example, template matching. When a one-dimensional code or a two-dimensional code is included, the processor 110 generates the one-dimensional code or the two-dimensional code and white plate data for printing the white ink at a position protruding from the one-dimensional code or the two-dimensional code (refer to (h) of FIG. 6). Therefore, according to the present embodiment, it is possible to obtain white plate data that can increase the possibility of accurately reading the one-dimensional code or the two-dimensional code.

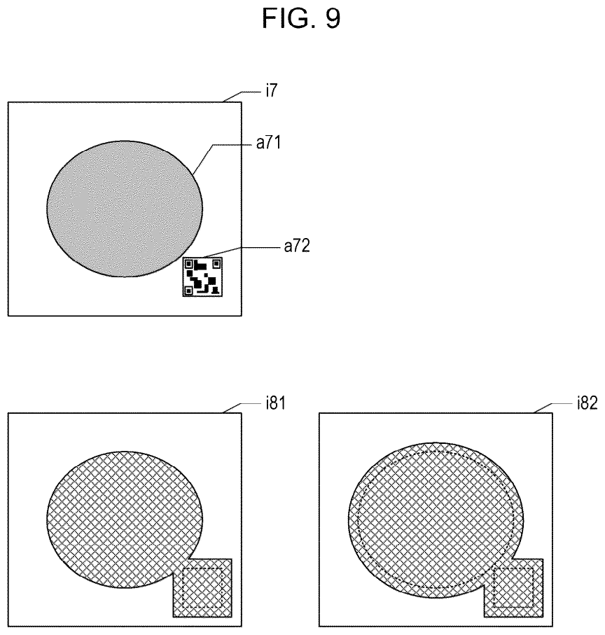

Undoubtedly, a plurality of objects exemplified above may be included in one piece of image data. For example, image data i7 in FIG. 9 shows an example in which an illustration a71 and a two-dimensional code a72 are included. As shown in (f) of FIG. 6, the illustration includes a pattern in which the white ink is printed in the same region without protruding and a pattern in which the white ink is printed in the same region with protruding, and the two-dimensional code includes only a pattern in which the white ink is printed with protruding. Therefore, the processor 110 creates one piece of white plate data in which the patterns of the respective objects are combined by the number of combinations. In the case of an image file i7 in FIG. 9, the processor 110 generates two pieces of white plate data i81 and i82. The white plate data i81 is white plate data indicating that white ink is printed in a region having the same position and size as the illustration a71 and in a region protruding from the two-dimensional code a72 and a72. The white plate data i82 is white plate data indicating that white ink is printed in a region protruding from the illustration a71 and a71 and a region protruding from the two-dimensional code a72 and a72.

In addition, a pattern in which the white ink is discharged to a region corresponding to the entire region to which the color ink is discharged in the image data may also be presented to the user. For example, in the original image i1 shown in FIG. 7, the background object b is also a region to which ink is discharged in the color plate, and as shown in i23 of FIG. 7, white plate data indicating that white ink is discharged to a region obtained by combining the region of the main object m and the region of the background object b, that is, the entire white plate data overlapping the entire image i1 may be generated and proposed.

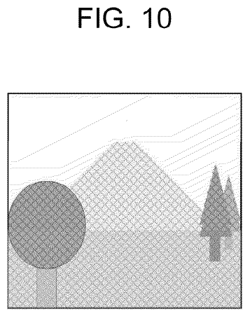

By the preview function, the processor 110 displays a print preview for each of a plurality of combinations of patterns corresponding to the types of objects as described above. For example, the print preview may display each plate of the image data i1 and the white plate data i2 in a three-dimensional manner as shown in FIG. 5, or may display each plate in a two-dimensional manner like the image data i5 and the white plate data i61 in FIG. 8. Alternatively, as shown in FIG. 10, the print preview may be displayed by hatching the region where the white ink is printed in the image data, or the print preview may be realized by alternately performing the hatching display indicating the combination of the image data and the white plate data as shown in FIG. 10 and the display of only the image data as shown in the image data i5 in FIG. 8.

As described above, by presenting a print preview for each combination of a plurality of patterns corresponding to the types of objects, it is possible to allow the user to examine and select the special plate data to be finished as desired by the user.

As described above, according to the present embodiment, the position at which the special color ink is printed with respect to the position of the object can be made different according to the type of the object included in the image data.

### (2) Printing Process

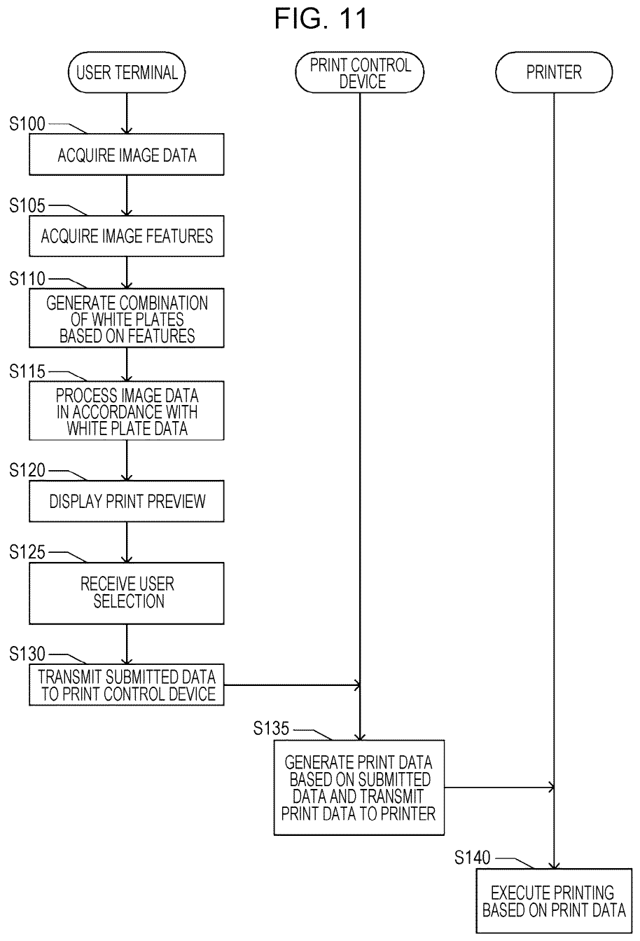

FIG. 11 is a flowchart showing a printing process. When the user creates and edits an image to be printed using the user terminal 100, the processor 110 of the user terminal 100 acquires the image to be printed (step S100). Then, the processor 110 acquires features of the image data (step S105). That is, the processor 110 determines the type of an object included in the image data by performing the various kinds of image recognition processing described above.

Then, the processor 110 generates a white plate combination based on the features (step S110). That is, the processor 110 generates white plate data according to a combination of one or more patterns corresponding to the type of each object included in the image data.

Then, the processor 110 processes the image data according to the white plate data (step S115). That is, as shown in i22 of FIG. 7, for image data corresponding to white plate data having a pattern in which white ink is printed so as to protrude from the object, the processor 110 processes the image data so that the region of a predetermined width w around the object becomes a region where no color ink is printed.

Then, the processor 110 displays the print preview (step S120). That is, the processor 110 presents a print preview of each combination of patterns corresponding to the types of objects. Then, the processor 110 receives a user's selection (step S125).

Then, the processor 110 transmits the submitted data to the print control device 300 (step S130). That is, the processor 110 configures the submitted data 130a including the white plate data and the image data corresponding to the print preview selected by the user, and transmits the submitted data 130a to the print control device 300.

The processor 310 of the print control device 300 generates print data based on the submitted data transmitted from the user terminal 100, and transmits the print data to the printer 200 (step S135). The processor 210 of the printer 200 performs printing based on the print data transmitted from the print control device 300 (step S140).

### (3) Other Embodiments

The above embodiment is an example for carrying out the present disclosure, and various other embodiments can be adopted. For example, a plurality of patterns of white plates may be automatically generated and selected by the user, but only one pattern may be automatically generated. In addition to the white plate shown in the above-described embodiment, the method of the present disclosure can also be applied when generating and printing various special plates. For example, the technique of the present disclosure can be applied to generation of a plate for printing a protective layer for protecting a printed color image or a plate for printing a line for cutting a print medium after printing.

In addition, the method of the present disclosure can be adopted in various types of printers that print a special plate. Specifically, in addition to the UV printer, for example, when a plate for performing printing on a direct to garment (DTG) is generated, the method of the present disclosure can be adopted. In addition, the method of the present disclosure can be applied to generation of a special plate for printing a clear ink or other various special color inks in addition to the white plate for printing a white ink.

The classification of the objects of the image data is not limited to the above-described embodiment. For example, some of the classifications described in the embodiment may be omitted, or classifications not described in the embodiment may be provided.

As a relative position at which the special color ink is printed in the special plate data with respect to the position of the object in the image data, a pattern (see FIG. 6) other than the pattern described in the above-described embodiment may be adopted. For example, a pattern may be adopted in which the special color ink is printed in a region a predetermined width inward from the outer edge of the object (a pattern in which the amount of protrusion is a negative value). For example, the amount of protrusion from the object may be set to be larger as the object is in focus. The density of the special color ink (the amount of ink per pixel) may be varied depending on the type of the object.

In addition, the present disclosure can also be applied as a program or a method executed by a computer. For example, the method of the above-described embodiment is also established as an invention of a printed matter generation method including: generating special plate data based on image data; printing the special plate data using special color ink; and printing the image data at a position overlapping the special color ink to generate a printed matter. A relative position between a position at which the special color ink of the special plate data is printed and a position of an object of the image data corresponds to a type of the object.

In addition, the method of the above-described embodiment is also established as a disclosure of a printing system including: a special plate generation unit that generates special plate data based on image data; a special plate printing unit that prints the special plate data using special color ink; and an image printing unit that prints the image data at a position overlapping the special color ink. A relative position between a position at which the special color ink of the special plate data is printed and a position of an object of the image data corresponds to a type of the object.

In addition, the method of the above-described embodiment is also established as a disclosure of a special plate data generation program, a special plate data generation method, or a special plate data generation system. The special plate data generation program causes a computer to execute: an object determination function for determining a type of an object in image data; and a special plate generation function for generating special plate data based on the image data. A relative position between a position at which special color ink of the special plate data is printed and a position of the object of the image data corresponds to a type of the object.

The special plate data generation method includes: determining a type of an object in image data; and generating special plate data based on the image data. A relative position between a position at which special color ink of the special plate data is printed and a position of the object of the image data corresponds to a type of the object.

The special plate data generation system includes: an object determination unit that determines a type of an object in image data; and a special plate generation unit that generates special plate data based on the image data. A relative position between a position at which special color ink of the special plate data is printed and a position of the object of the image data corresponds to a type of the object.

In addition, the system, the program, and the method described above may be realized as a single device or may be realized by using components included in a plurality of devices, and various forms thereof are included. In addition, the configuration can be appropriately changed in such a manner that a part of the configuration is software and a part of the configuration is hardware. In addition, the disclosure can also be realized as a recording medium for a program for controlling the system. Undoubtedly, the recording medium for the program may be a magnetic recording medium or a semiconductor memory, and any recording medium to be developed in the future can be considered in the same manner.

What is claimed is:

1. A non-transitory computer-readable storage medium storing a program, the program comprising: a special plate generation function for generating special plate data based on image data;
a special plate printing function for printing the special plate data using special color ink; and
an image printing function for printing the image data at a position overlapping the special color ink,
wherein a relative position between a position at which the special color ink of the special plate data is printed and a position of an object of the image data corresponds to a type of the object.

2. The storage medium according to claim 1, wherein, when a person is a main object in the image data, the special plate generation function generates the special plate data indicating that the special color ink is printed at a position of a person object indicating the person and a position protruding from the person object.

3. The storage medium according to claim 1, wherein, when an illustration is a main object in the image data, the special plate generation function generates the special plate data indicating that the special color ink is printed at a position of the illustration and a position protruding from the illustration.

4. The storage medium according to claim 1, wherein, when the image data includes a one-dimensional code or a two-dimensional code, the special plate generation function generates the special plate data indicating that the special color ink is printed at a position of the one-dimensional code or the two-dimensional code and a position protruding from the one-dimensional code or the two-dimensional code.

5. The storage medium according to claim 1, wherein, when a landscape is a main object in the image data, the special plate generation function generates the special plate data indicating that the special color ink is not printed at a position corresponding to sky and the special color ink is printed without protruding to a position corresponding to an object that is not the sky.

6. The storage medium according to claim 1, wherein, when the image data is a photograph, the special plate generation function generates the special plate data indicating that the special color ink is printed at a position of an object in focus without protruding from the object.

7. The storage medium according to claim 6, wherein, when the image data is a photograph, the special plate generation function generates the special plate data indicating that the special color ink is not printed at a position corresponding to an object out of focus and the special color ink is printed at a position corresponding to an object in focus.

8. The storage medium according to claim 1, wherein the special plate generation function generates a plurality of pieces of the special plate data,
a preview function for performing a print preview in a selectable manner for each piece of the special plate data is executed, and
the special plate printing function prints the special color ink based on the selected special plate data.

9. The storage medium according to claim 1, wherein the special plate generation function processes the image data according to a type of the object.

10. A printed matter generation method, comprising: generating special plate data based on image data;
printing the special plate data using special color ink; and
printing the image data at a position overlapping the special color ink to generate a printed matter,
wherein a relative position between a position at which the special color ink of the special plate data is printed and a position of an object of the image data corresponds to a type of the object.

11. A printing system, comprising: a special plate generation unit that generates special plate data based on image data;
a special plate printing unit that prints the special plate data using special color ink; and
an image printing unit that prints the image data at a position overlapping the special color ink,
wherein a relative position between a position at which the special color ink of the special plate data is printed and a position of an object of the image data corresponds to a type of the object.

12. A special plate data generation method, comprising: determining a type of an object in image data; and
generating special plate data based on the image data,
wherein a relative position between a position at which special color ink of the special plate data is printed and a position of the object of the image data corresponds to a type of the object.

13. A special plate data generation system, comprising: an object determination unit that determines a type of an object in image data; and
a special plate generation unit that generates special plate data based on the image data,
wherein a relative position between a position at which special color ink of the special plate data is printed and a position of the object of the image data corresponds to a type of the object.

14. A non-transitory computer-readable storage medium storing a program, the program comprising: an object determination function for determining a type of an object in image data; and
a special plate generation function for generating special plate data based on the image data,
wherein a relative position between a position at which special color ink of the special plate data is printed and a position of the object of the image data corresponds to a type of the object.
